(19) United States
(12) Patent Application Publication
(10) Pub. No.: US 2012/0065005 A1
(43) Pub. Date: Mar. 15, 2012

(54) Advertising device for sports goals

(76) Inventors: Ignacio Iriarte Sanllehi, Barcelona (ES); Borja Cumella Gaminde, Barcelona (ES)

(21) Appl. No.: 13/199,742

(22) Filed: Sep. 8, 2011

(30) Foreign Application Priority Data
Sep. 8, 2010 (ES) 201030919

(51) Int. Cl. A63B 63/00; G09F 15/00; G09F 7/00

(52) U.S. Cl. 473/478; 40/584; 40/606.01

(57) ABSTRACT

An advertising or other display device for sports goals designed to place advertising or other displays on the field remote from the scene of action, visible to spectators and television broadcasts of sporting events. The advertising or other display device comprises a transparent element, supports for supporting the transparent element and opaque, semitransparent or translucent areas on the transparent element for forming a design, sign or logo. The opaque, semitransparent or translucent areas have the same or similar color as the color of the net of the goal to create an optical effect that the opaque, semitransparent or translucent areas are incorporated into the net of the goal, from various points of view.

This application claims foreign priority based on Spanish Patent Application Serial No. 201030919 filed Sep. 8, 2010, the content of which is incorporated herein by reference in its entirety.

### BACKGROUND OF THE INVENTION

1. Field of the Invention

The application field of this invention is the advertising media industry in stadiums and sports areas hosting sporting events. Specifically, the present invention relates to an advertising device for sports goals with nets, designed to place advertising on the field behind the scene of action, visible to spectators and television broadcasts of sporting events with an optical effect of incorporation of the advertising into the goal or net of the goal.

2. Description of the Prior Art

Currently, sporting events are big events that attract the attention of many people, who either attend the event or observe it through broadcasts on TV, the Internet, DVDs etc.

For example it is common to place advertising posters and other displays around the playing field at football stadiums, soccer stadiums, basketball courts, team handball courts, and other fields of play.

In many sports such as soccer, indoor soccer, team handball, hockey and others, goals with nets are used at opposite ends of these courts, rinks or fields, where the objective is for the ball, puck, etc. to enter the goal in order to score. Therefore, these goals are the important points of action where play on the field is more intense and therefore more attractive for the placement of advertising or other displays, since spectators will pay more attention to observe such points of action.

For example, it is known to use an advertising billboard on folding support means for positioning the billboard along both sides of the goals, where the print advertising is either static or includes means for dynamic moving advertisements, such as rotation of the billboard to view different advertisements. The support means are foldable or collapsible to prevent a player from injuring himself when the player leaves the field of action due to stumbling, tripping, sliding etc. However, these billboard panels are only on one or both sides of the goal, but not directly behind and in close proximity to the goal. Moreover, these billboard panels always leave a space of safety away from the center of the goal which limits the view of such billboards, especially when the television camera focuses directly on the goal itself with a close up view.

There are also known signs which are placed flat on the ground around the playing field, which visually provide the appearance of a three-dimensional sign during a televised sports broadcast, although the sign is a flat design on the ground of the playing field. This type of sign includes the advertisement in a distorted way on the flat field to recreate the optical effect of a three-dimensional perspective when seen from the television camera from certain points of view. The main problem with this type of advertising is that the broadcasting camera must be at a certain height and angle to view the 3-D advertisement properly, and such advertising cannot be seen clearly during a close up view of the goal by the broadcasting camera.

### SUMMARY OF THE INVENTION

The advertising device for sports goals is intended to provide a novel advertising support which does not interfere in the field of play during the sport, and allows for quick and effective customization.

An object of the present invention is to provide a device applicable to sports goals comprising an anterior frame from which a net of the goal hangs extending from the anterior frame, and the net having a certain color.

Another object of the present invention is to provide a device comprising a transparent element having a configuration for rendering said transparent element observable by spectators viewing the net.

It is an object of the present invention is to provide a device comprising a transparent element in a vertical or inclined position, equipped with transparent supports for disposition behind the net of the goal, where the transparent element includes opaque, semitransparent or translucent areas having the same or similar color as the color of the net, to form a design, sign or logo to create an optical effect that the opaque, semitransparent or translucent areas are incorporated into the net of the goal, from various points of view.

Still another object of the present invention to provide a viewable device having white or other color (or colors) opaque, semitransparent or translucent areas with a design, sign or logo thereon to match the white color (or any other color or mixture of colors) of the net, resulting in an effect that design, sign or logo is directly on the net.

Yet another object of the present invention is to provide a device for use in association with a netted goal for a game with a transparent element so as not to hinder the visibility of the game to viewers behind the goal.

Another object of the present invention is to provide a viewable device for use on an athletic field or rink having thereon grass, dirt, sand, ice etc, the viewable device having an optical effect produced by the semitransparent or opaque areas on the device, so that it appears that the design, sign or logo disposed on the device appears to float over the grass, dirt, sand, ice, etc. of the field or rink giving a three-dimensional effect.

It is still another object of the present invention to provide removable adhesive sheets such as vinyl sheets for forming the opaque or semi-transparent areas on the forgoing type of device.

A further object of the present invention is to provide a device as described above for use with goals having nets, the device having a long service life where the device can be configured to be easily interchangeable with different designs, signs or logos.

Another object of the present invention is to provide the foregoing type of device for use with goals having nets for use with games played on large areas before spectators, which has a low risk of intervening in the game or being damaged by players since it is behind the goal area off the field of play.

### BRIEF DESCRIPTION OF THE DRAWINGS

So as to complement the description given herein and with the purpose of facilitating the comprehension of the characteristics of the invention, the present descriptive report is accompanied by a set of drawings where, with an illustrative and non limiting character, the following are represented according to preferred embodiments of the invention:

FIG. 1 is a front view of an advertising or other display device located behind a goal with a net.

FIG. 2 is a side profile view of the advertising or other display device as shown in FIG. 1 placed behind a sports goal having a net.

FIG. 3 is a front view of the advertising or other display device placed behind a sports goal as shown in FIG. 2, showing a visual integration of opaque, semitransparent or translucent areas with the net of the sports goal.

FIG. 4 is a perspective view of the advertising or other display device according to another embodiment of the invention.

FIG. 5 is a side profile view of the advertising or other display device of FIG. 4.

FIG. 6 is a front view of the advertising or other display device of FIG. 4.

FIG. 7 is a top view of the advertising or other display device of FIG. 4.

FIG. 8 is a perspective view of yet another embodiment of the advertising or other display device.

FIG. 9 is a side profile view of the advertising or other display device of FIG. 8.

FIG. 10 is a front view of the advertising or other display device of FIG. 8.

FIG. 11 is a top view of the advertising or other display device of FIG. 8.

### DETAILED DESCRIPTION OF THE PREFERRED EMBODIMENTS

As shown in the referenced figures, the device is applicable in sports goals having nets (as used hereafter, “goals” means goals or other items having nets which may be viewed by spectators), and particularly behind a sports goal and off the actual field or rink of play. As shown in FIGS. 2 and 3, a sports goal 1 comprises an anterior frame 11 from which hangs a net 12. Net 12 has a specific color and partially extends from anterior frame 11 and off the field of play (assuming it is used with such athletic events such as soccer, team handball etc.). Net 12 may be any color but oftentimes is white. Net 12 may be supported by posterior props 13 which allow net 12 to remain taut as shown in FIG. 2. Alternatively, anterior frame 11 may comprise additional frame members (not shown) which hold net 12 taut. The net could be inclined or have other shapes as well.

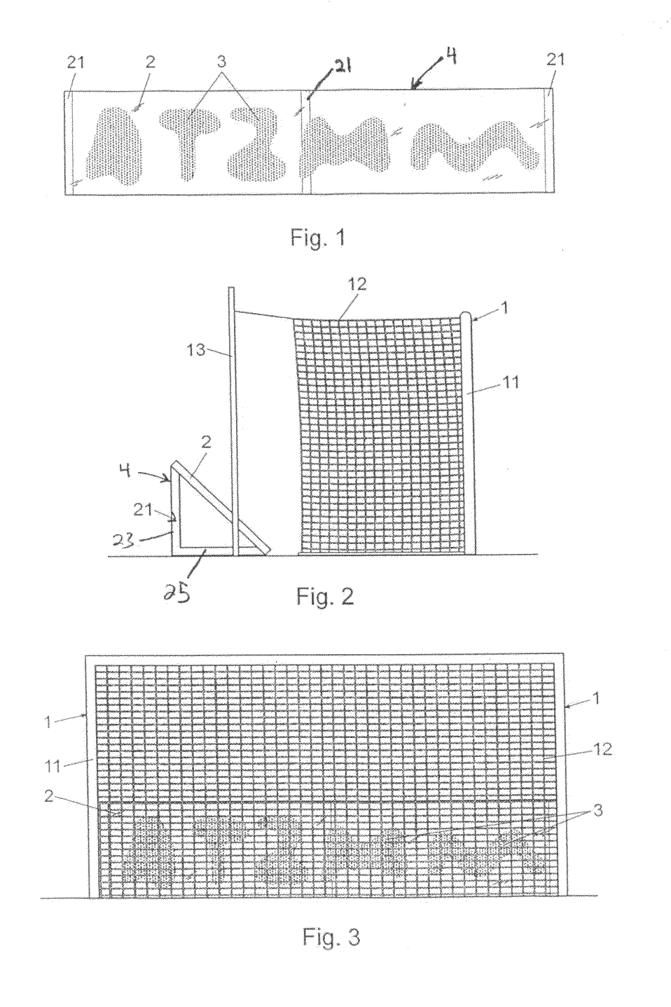

With reference to FIG. 1, an advertising device 4 for a sports goal is shown. Advertising device 4 comprises a transparent flat or planar element 2 which is inclined with respect to the horizontal field of play as shown in FIG. 2. Planar element 2 is supported by supports 21. Supports 21 are “L-shaped” to support planar element 2 in an inclined position as shown in FIG. 2. That is, supports 21 include a vertical support 23 with respect to the horizontal playing field (“field” hereinafter includes other such areas as courts, rinks, pools, etc.) and a horizontal support 25 parallel the horizontal playing field.

Planar element 2 is completely transparent, so objects can be seen while looking through planar element 2. In a preferred embodiment, planar element 2 comprises a rigid methacrylate panel, although other types of transparent panels may be used such as plastic, vinyl or glass. Supports 21 of planar element 2 also preferably comprise transparent methacrylate allowing vision through supports 21.

Advertising device 4 further comprises opaque, semitransparent or translucent areas 3 formed by planar portions of vinyl. Such opaque, semitransparent or translucent areas may comprise removable adhesive sheets such as vinyl sheets which can be superficially adhered to and removable from planar element 2. Opaque, semitransparent or translucent areas 3 can form any type of design, sign or logo on planar element 2. Opaque, semitransparent or translucent areas 3 are preferably the same or similar color as net 12 so that one or more anterior points of view in front of sports goal 1 are visually blended together. Stated another way, the same colored opaque, semitransparent or translucent areas 3 and net 12 blend together as if to form a single colored entity to make net 12 appear as if it is imprinted with opaque, semitransparent or translucent areas 3. Therefore, if net 12 is white, opaque, semitransparent or translucent areas should also be white or similar to the color white.

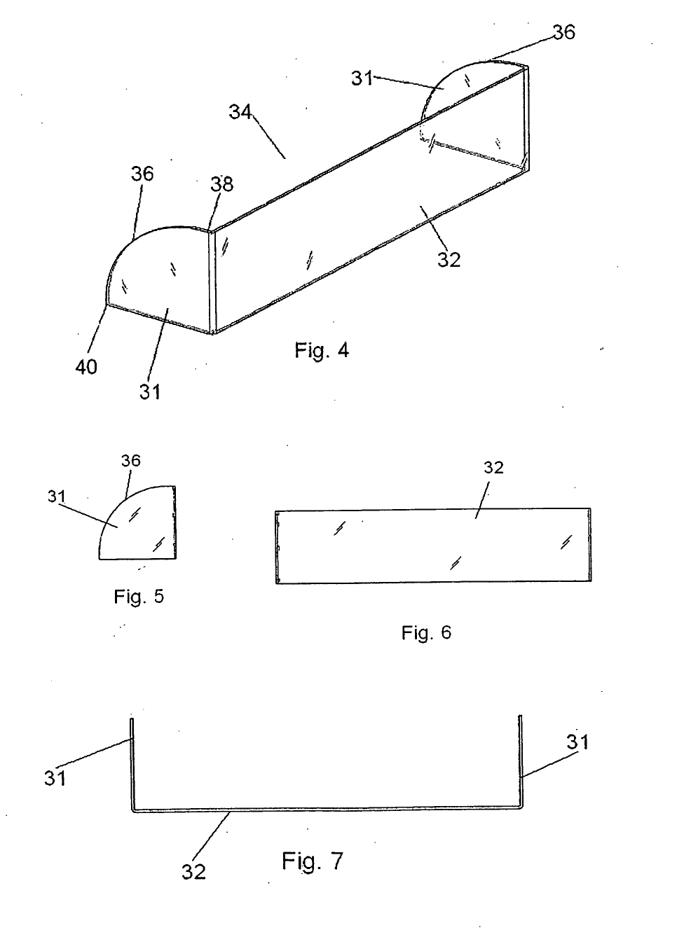

Referring to FIGS. 4-7, another embodiment of the present invention is shown. An advertising device 34 for a sports goal is shown in FIG. 4 having a modified structure from advertising device 4 seen in FIGS. 1-3. Advertising device 34 includes a transparent planar element 32 which is vertical with respect to the horizontal field of play. Planar element 32 is supported by supports or sidewalls 31 which are perpendicular to either side of planar element 32 as seen in FIG. 7. FIG. 5 shows that sidewalls 31 include a curved surface 36 which provides a sleek and smooth transition from a top corner 38 of sidewall 31 to a bottom opposite corner 40 of sidewall 31. In the present embodiment, sidewalls 31 are solid surfaces, but could include a frame-like structure similar to L-shaped supports 21 in FIGS. 2 and 3 in order to reduce the material to be used to form sidewalls 31.

Planar element 32 and sidewalls 31 are completely transparent, so objects can be seen while looking through planar element 32 and sidewalls 31. Planar element 32 and sidewalls 31 comprise a rigid methacrylate panel, although other types of transparent panels may be used such as plastic, vinyl or glass. Sidewalls 31 are transparent so as not to cause a distraction to viewers when viewing a design, sign or logo formed by opaque, semitransparent or translucent areas 3 discussed above. Opaque, semitransparent or translucent areas 3 are formed and function on planar element 32 in the same manner as described above and will not be repeated here.

Advertising device 34 is freestanding as sidewalls 31 fully support planar element 32 as shown in FIG. 4. This allows planar element 32 to remain in a vertical position with respect to the horizontal playing field in order to view the design, sign or logo formed by opaque, semitransparent or translucent areas 3 (not shown in FIGS. 4-7).

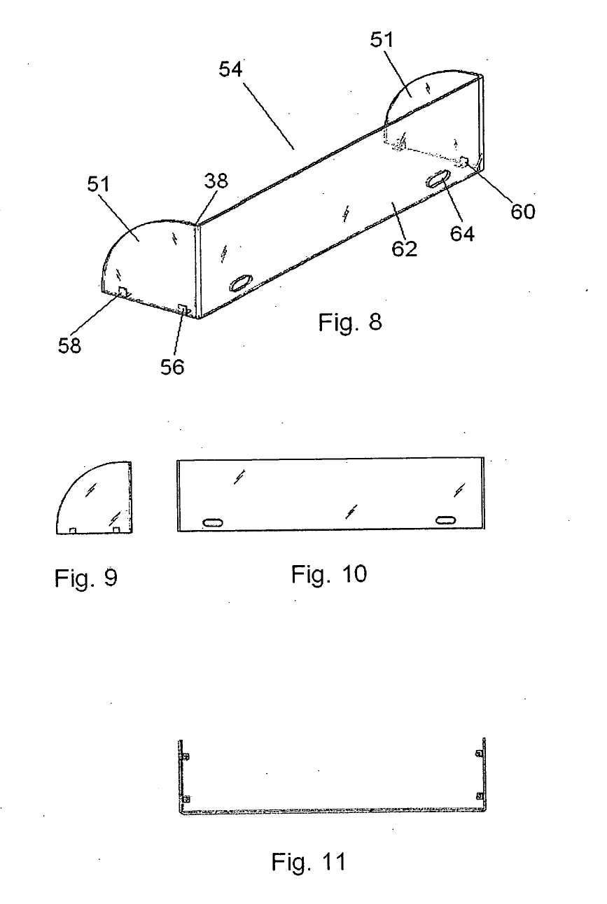

A further modified embodiment of FIGS. 4-7 is shown as advertising device 54 in FIGS. 8-11. Since many sporting events are held outdoors, various types of weather could impact advertising device 54 causing it to shift or move. For example, strong winds could cause advertising device 54 to move out of position behind the sports goal or even possibly tip over, causing advertising device 54 to not be viewable. Therefore, it is essential that advertising device remain in a fixed position behind the sports goal in order to properly display and view the design, sign or logo formed by opaque, semitransparent or translucent areas 3 (not shown in FIGS. 8-11). In order to accomplish this, advertising device 54 includes brackets 56 on each sidewall 51 as shown in FIGS. 8, 9 and 11. Brackets 56 are preferably “L-shaped” having a vertical bracket surface 58 and horizontal bracket surface 60. Vertical bracket surface 58 attaches and is parallel to sidewall 51 as shown in FIG. 8. Horizontal bracket surface 60 is parallel to the horizontal playing field (not shown). Horizontal bracket surface 60 may be attached to sidewalls 31 by any number of known means, including fasteners, adhesives etc. Horizontal bracket surface 60 includes a hole 62 to accommodate some type of attaching device, such as a ground stake (not shown), to secure bracket surface 60 into the ground of the playing field. Therefore, even in inclement weather conditions such as strong winds, advertising device 54 will remain in a fixed position behind sports goal, and the design, sign or logo formed by opaque, semitransparent or translucent areas 3 will remain viewable during such weather conditions.

In order to transport advertising device 54, a person or persons can lift either sidewalls 51 or planar element 52. Alternatively, handles 64 in the form of oval-shaped openings are located on planar element 52 as seen in FIGS. 8 and 10. Handles 64 allow advertising device 54 to be easily lifted and transported to another location.

Although planar element 2, 32, 52 is flat in the above described embodiments, the transparent element can have a configuration for rendering the transparent element observable by spectators viewing the net. For example, the transparent element may be curved to match the curvature of the net, such as a hockey net or lacrosse net. In this instance, transparent element would have a curved configuration generally similar to the defined curvature of the net. Thus, transparent (or translucent) element need not be planar.

The above described invention is a very inexpensive yet effective form of advertising. If it desired that the design, sign or logo formed by opaque, semitransparent or translucent areas 3 be changed during a sporting event, opaque, semitransparent or translucent areas 3 can simply be removed from planar element 2 and replaced with a different design, sign or logo having different opaque, semitransparent or translucent areas 3. For example, this could quickly be done during a commercial if the sporting event is broadcast on television so television viewers would not even see the change being made. Alternatively, the entire advertising device 4, 34, 54 could be replaced with a different advertising device having a different design, sign or logo having different opaque, semitransparent or translucent areas. Such a change in advertising is common during sporting events where, for example, the first half of the sporting event is sponsored by one sponsor while the second half is sponsored by another sponsor.

Having sufficiently described the nature of the invention as well as a preferred embodiment, it is noted the effects that the materials, shape, size and arrangement of the elements described can be modified, provided that this does not alter essential features of the invention claimed below.

What is claimed:

1. A display device for a sports goal for a playing field, the sports goal having an anterior frame and a net disposed on the anterior frame, the net having a certain color and extending from the anterior frame, said display device being arranged behind the net comprising:
a transparent element having a configuration for rendering said transparent element observable by spectators viewing the net;
at least one transparent support for supporting said transparent element; and
at least one opaque, semitransparent or translucent area on said transparent element comprising the same or similar color to the color of the net, said at least one opaque, semitransparent or translucent area forming a design, sign or logo;
wherein said at least one opaque, semitransparent or translucent area creates an optical effect of said at least one opaque, semitransparent or translucent area being incorporated into the net of the goal when viewed from various points of view from the anterior frame.

2. A display device according to claim 1 wherein said configuration is substantially flat.

3. A display device according to claim 1 wherein the net on the goal has a defined curvature, and said configuration has a curvature generally similar to the defined curvature of the net.

4. A display device according to claim 1 wherein said transparent element is inclined with respect to the playing field.

5. A display device according to claim 1 wherein said transparent element is vertical with respect to the playing field.

6. A display device according to claim 1 wherein said at least one opaque, semitransparent or translucent area is formed by at least one removable adhesive sheet.

7. A display device according to claim 1 wherein said at least one removable sheet comprises vinyl.

8. A display device according to claim 1 wherein said at least one transparent support comprises an L-shape.

9. A display device according to claim 1 wherein said transparent element comprises a rigid methacrylate panel.

10. A display device according to claim 1 wherein said transparent element comprises plastic, vinyl or glass.

11. A display device according to claim 1 wherein said at least one transparent support is perpendicular to said transparent element.

12. A display device according to claim 1 wherein said at least one transparent support comprises a curved surface from a top corner of said at least one transparent support to a bottom corner of said at least one transparent support.

13. A display device according to claim 1 further comprising at least one bracket on said at least one transparent support for securing said display device to the playing field.

14. A display device according to claim 13 wherein said at least one bracket comprises a vertical bracket surface and a horizontal bracket surface forming an L-shape.

15. A display device according to claim 14 wherein said horizontal bracket surface includes an opening for accommodating a ground stake to secure said display device to the playing field.

16. A display device according to claim 1 further comprising at least one handle on said transparent element for carrying said display device.

17. A goal with a net in combination with a display device, said goal having an anterior frame with the net disposed on the anterior frame, the net having a certain color and extending from the anterior frame, said display device being arranged behind the net comprising:
a transparent element having a configuration for rendering said transparent element observable by spectators viewing the net;
at least one transparent support for supporting said transparent element; and
at least one opaque, semitransparent or translucent area on said transparent element comprising the same or similar color to the color of the net, said at least one opaque, semitransparent or translucent area forming a design, sign or logo;
wherein said at least one opaque, semitransparent or translucent area creates an optical effect of said at least one opaque, semitransparent or translucent area being incorporated into the net of the goal when viewed from various points of view from the anterior frame.

18. A display device according to claim 17 wherein said configuration is substantially flat.

19. A display device according to claim 17 wherein the net on the goal has a defined curvature, and said configuration has a curvature generally similar to the defined curvature of the net.
